(19) United States
(12) Patent Application Publication
(10) Pub. No.: US 2007/0053800 A1
(43) Pub. Date: Mar. 8, 2007

(54) Fluid processing device comprising sample transfer feature

(75) Inventor: Dennis A. Lehto, Santa Clara, CA (US)

Correspondence Address: KILYK & BOWERSOX, P.L.L.C., 3603 CHAIN BRIDGE ROAD, SUITE E, FAIRFAX, VA, 22030, US

(73) Assignee: Applera Corporation, Foster City, CA (US)

(21) Appl. No.: 11/219,225

(22) Filed: Sep. 2, 2005

(51) Int. Cl. B01L 3/00

(52) U.S. Cl. 422/102

(57) ABSTRACT

Devices for fluid processing, systems that comprise such devices, and methods that use such devices and/or systems are provided. Such fluid processing devices, systems that include such devices and methods that use such devices and/or systems can be used in any application that involves controlled sample transfer including PCR or other DNA-based procedures as well as other types of molecular biology procedures.

### INTRODUCTION

The section headings used herein are for organization purposes only and are not to be construed as limiting the subject matter described in any way. While application teachings are described in conjunction with various embodiments, it is not intended that such teachings be limited to such embodiments. On the contrary, the application teachings encompass various alternatives, modifications and equivalents, as will be appreciated by those of skill in the art.

Various embodiments of the present teachings relate to fluid processing devices, systems that can include fluid processing devices and methods that can use fluid processing devices and/or systems. Devices and/or systems can manipulate, process, or otherwise alter micro-, nano-, or pico-sized amounts of fluids and fluid samples. There exists a demand for fluid processing devices, methods of using fluid processing devices, and systems incorporating fluid processing devices for processing samples that are fast, reliable and can be used to process large numbers of samples simultaneously. Fluid processing devices can be used, for example, in any application that involves controlled sample transfer. Uses for fluid processing devices, systems that include such devices, and methods that use such devices and/or systems can include PCR or other DNA-based procedures as well as other types of molecular biology assays and procedures.

### SUMMARY

According to various embodiments, a fluid processing device is provided that comprises a substrate comprising a first surface, an opposite second surface, a plurality of through-holes extending from the first surface to the second surface, a first side edge, a second side edge opposite the first side edge, and at least one feed channel, the at least one feed channel comprising a zig-zag shape and including a plurality of peaks and a plurality of troughs. In various embodiments, each of the peaks can be closer to the first side edge than an adjacent trough is to the first side edge, and each of the troughs can be closer to the second side edge than an adjacent peak is to the second side edge. Each of the troughs can be in fluid communication with at least one of the plurality of through-holes through a respective fluid communication. In various embodiments, each respective fluid communication can be adapted to prevent an aqueous solution from passing from the at least one feed channel into the respective at least one through-hole under a force required for loading an aqueous solution into the at least one feed channel.

According to various embodiments, a sample processing system is provided that comprises a fluid processing device comprising a substrate comprising a first surface, an opposite second surface, a plurality of through-holes extending from the first surface to the second surface, a first side edge, a second side edge opposite the first side edge, and at least one feed channel. The at least one feed channel can comprise a zig-zag shape and include a plurality of peaks and a plurality of troughs, wherein each of the peaks can be closer to the first side edge than its corresponding trough is to the first side edge, each of the troughs can be closer to the second side edge than its corresponding peak is to the second side edge, and each of the troughs can be in fluid communication with at least one of the plurality of through-holes through a respective fluid communication. Each respective fluid communication can be adapted to prevent an aqueous solution from passing from the at least one feed channel into the respective at least one through-hole under a force required for loading an aqueous solution into the at least one feed channel. In various embodiments, the sample processing system can comprise a processing apparatus, the processing apparatus comprising a rotatable platen, a holder capable of holding the fluid processing device on or in the platen, and a drive unit to rotate the platen about an axis of rotation.

According to various embodiments, a method of distributing a liquid sample is provided that comprises providing a fluid processing device comprising a substrate comprising a first surface, an opposite second surface, a plurality of through-holes extending from the first surface to the second surface, a first side edge, a second side edge opposite the first side edge, and at least one feed channel. The at least one feed channel can comprise a zig-zag shape and include a plurality of peaks and a plurality of troughs, wherein each peak is closer to a first side edge than an adjacent trough is to the first side edge, each of the troughs is closer to a second side edge than an adjacent peak is to the second side edge, and each of the troughs can be in fluid communication with at least one of a plurality of through-holes through a respective fluid communication. In various embodiments, each respective fluid communication is adapted to prevent an aqueous solution from passing from the at least one feed channel into the respective at least one through-hole under a force required for loading an aqueous solution into the at least one feed channel.

These and other features of the application teachings are set forth herein and in part will be apparent from the description or practice of various embodiments. It is to be understood that both the foregoing general description and the following detailed description are exemplary and explanatory only. The accompanying drawings, which are incorporated into and constitute a part of this application, illustrate several exemplary embodiments.

### DRAWINGS

The skilled artisan will understand that the drawings described below, are for illustration purposes only. The drawings are not intended to limit the scope of the present teachings in any way.

FIG. 1A is a perspective view of a fluid processing device comprising a substrate having a first surface, loading or feed channels, through-holes, and a reservoir, according to various embodiments;

FIG. 1B is a perspective view of a second surface opposite the first surface of the substrate of the fluid processing device shown in FIG. 1A;

FIG. 1C is a perspective, cutaway view of fluid processing device shown in FIGS. 1A and 1B;

FIG. 2A is an enlarged top-plan view of a portion of the first surface of the fluid processing device;

FIG. 2B is a perspective view of the first surface of the fluid processing device;

FIG. 3 is a perspective, cutaway view of the second surface of the fluid processing device;

FIG. 4A is a perspective view of fluid processing device comprising a through-hole and a bead disposed in the through-hole;

FIG. 4B is a perspective view wherein the bead has melted against a sidewall of the through-hole;

FIG. 5 is a perspective view of the fluid processing device restraining the flow path of a sample pumped or drawn by a force, for example, a capillary force, into the feed channel;

FIG. 6 is a perspective view of the fluid processing device, wherein the sample has flowed from the feed channel to the through hole after the fluid processing device has been spun, and discreet volumes of the sample have been formed by peaks and troughs comprising the feed channel;

FIG. 7 is a perspective view of the fluid processing device wherein sample has flown through the feed channel and into the through-hole;

FIG. 8 is a perspective view of a wax plug disposed in the feed channel adjacent the through-hole; and

FIG. 9 is a perspective view showing the wax plug of FIG. 8 melted and plugging the connecting channel following application of heat and centripetal force; and

FIG. 10 is a perspective view of a fluid processing system comprising a platen, device holders, a platen drive unit, and a fluid processing device as described herein.

### DESCRIPTION

Reference will now be made to various embodiments, examples of which are illustrated in the accompanying drawings. Wherever possible, the same reference numbers are used in the drawings and the description to refer to the same or like parts.

Throughout the application descriptions use “comprising” language, however, it will be understood by those of skill in the art, that in some instances, descriptions of related embodiments can alternatively use the language “consisting essentially of” or “consisting of.”

For purposes of better understanding the invention and in no way limiting the scope of the invention, it will be clear to one of skill in the art that the use of the singular includes the plural unless specifically stated otherwise. Therefore, the terms “a,” “an” and “at least one” are used interchangeably in this application.

The terms channel and conduits can be used interchangeably.

The term zig-zag should be understood to mean sinusoidal, serpentine, jagged, saw-toothed or the like. A zig-zag shape can include, but is not limited to, a series of “V” or U-shaped channel portions in fluid communication with one another.

According to various embodiments, a device is provided for performing various biochemical methods in individual wells. The device can incorporate milli-, micro-, nano-, or pico-sized fluidic channels and valves to distribute liquid samples into individual reaction sites or wells. Biochemical methods can comprise methods related to either protein or nucleic acid analysis. Nucleic acid analysis can comprise, for example, a polymerase chain reaction (PCR), a chain ligase reaction, a reverse-trascriptase polymerase chain reaction (RT-PCR), or a sequencing reaction.

According to various embodiments, a fluid processing device comprising a substrate is provided. The substrate can comprise a first surface, a second surface opposite the first surface, a plurality of through-holes extending from the first surface to the second surface, a first side edge, a second side edge opposite the first side edge, and at least one feed channel. The feed channel can comprise a zig-zag shape. The feed channel can include a plurality of peaks and a plurality of troughs. Each of the troughs can be in fluid communication with at least one of a plurality of through-holes through a respective fluid communication. The feed channel can comprise a series of V-shaped sections of peaks and troughs, or other shapes as deemed appropriate. A respective fluid communication can be adapted to prevent an aqueous solution from passing from the at least one feed channel into the respective at least one through-hole under a force required for loading an aqueous solution into the at least one feed channel.

According to various embodiments, each zig-zag shaped section or segment of a feed channel can define a first volume. Each through-hole can define a second volume. The second volume can be about the same as the first volume. In various embodiments, each of the peaks in a row of a feed channel can be closer to the first side edge than to the second side edge, each of the troughs in the same row of a feed channel can be closer to the second side edge than to the first side edge, and each of the troughs can be in fluid communication with at least one respective through-hole of a plurality of through-holes.

According to various embodiments, each respective fluid communication can be adapted to prevent an aqueous solution from passing from the at least one feed channel into the respective at least one through-hole under a force required for loading an aqueous solution into the at least one feed channel. In various embodiments, a fluid communication can comprise at least one hydrophobic surface adapted to prevent an aqueous solution from passing from the at least one feed channel into a respective through-hole, for example, during loading of the feed channel.

According to various embodiments, the fluid processing device can comprise a cover layer attached to one or more of a first surface and a second surface. The cover layer can be sealed to the first surface. A second cover layer can be sealed to the second surface. A portion of the substrate, a portion of a cover layer, and at least one end of a through-hole, can together form a well.

According to various embodiments, the substrate can be round and comprise a periphery. The first and second side edges of the substrate can comprise respective portions of the periphery. In various embodiments, the substrate can comprise a rectangular plate or other geometric or irregular shape as may be desired. In various embodiments, the substrate can comprise a polymeric material.

According to various embodiments, the fluid processing device can comprise an input port and a reservoir. The reservoir can be in fluid communication with at least one feed channel. A fluid communication can comprise an opening and/or a channel. The input port can be in non-valved fluid communication with the reservoir or in valved fluid communication with the reservoir.

According to various embodiments, the second surface of the fluid processing device can comprise a tapered entry for a through-hole. In various embodiments, the tapered entry can comprise a flat surface that is perpendicular or substantially perpendicular to a second surface, for example, the tapered entry can comprise a non-tapered flat portion.

According to various embodiments, the fluid processing device can comprise a reagent-containing bead in at least one through-hole. Each reagent-containing bead can be melted onto an interior surface of a respective through-hole. In various embodiments the reagent-containing bead can comprise a polyethylene glycol or polyethylene glycol derivative material.

According to various embodiments, the substrate can comprise a plurality of chambers. Chambers can comprise wells, each chamber in fluid communication with a reservoir via a loading or feed channel. Various embodiments of the fluid processing device can process various volumes, for example, micro-titer, nano-titer or pico-titer volumes, of a sample in various formats, for example, sample trays or multi-well plates.

According to various other embodiments, the fluid processing device can be used for processing liquid materials in multiple wells for a desired reaction, for example, a nucleic acid amplification, a ligase chain reaction, a self-sustaining sequence replication, an enzyme kinetic study, an homogeneous ligand binding assay, a sequencing reaction, or other biochemical reactions requiring a thermal variation. In some embodiments, processing of samples can comprise processes related to peptide or polypeptide manipulation.

According to various embodiments, a system can be configured for thermally cycling samples of biological material in a fluid processing device using a thermal cycling device. The thermal cycling device can be configured to perform nucleic acid amplification on samples of biological material or can be configured for other molecular biology approaches. One common method of performing nucleic acid amplification of biological samples can be a polymerase chain reaction (PCR). Various PCR methods including RT-PCR are known in the art, as described in, for example, U.S. Pat. Nos. 5,928,907 and 6,015,674 to Woudenberg et al., the complete disclosures of which are incorporated in their entireties herein by reference. Other methods of nucleic acid amplification can include, for example, ligase chain reactions, or transcription-mediated amplification. One of skill in the art would be aware that methods can be used to amplify either DNA or RNA samples.

According to various embodiments, the substrate can be used in a thermal cycling device that performs real-time detection of the nucleic acid amplification of the samples during thermal cycling. Real-time detection systems are known in the art, for example, U.S. Pat. Nos. 5,928,907 and 6,015,674 to Woudenberg et al., incorporated in their entirety herein by reference. During real-time detection, various characteristics of samples can be detected during thermal cycling in a manner known in the art. Real-time detection can permit accurate and efficient detection and monitoring of samples during the nucleic acid amplification process.

According to various embodiments, the substrate can be used in a thermal cycling device that performs endpoint detection of nucleic acid amplification of samples. Several types of detection apparatus are shown in WO 02/00347A2 to Bedingham et al., incorporated in its entirety by reference herein.

According to various embodiments, a fluid processing device is provided for performing PCR tests in isolated wells. The device can comprise micro-fluidic channels and valves to distribute liquid samples into individual wells. In various embodiments, the device can comprise a thin, flat rectangular plate that can be molded out of plastic. The rectangular plate can have an array of through holes.

The array can have a rectangular pattern. When the substrate is used in combination with a cover, through-holes in the substrate can form wells for various reactions, for example, a PCR reaction. Narrow, serpentine channels can connect the wells. A liquid sample can fill the channels either by capillary force or by pumping in the liquid with a syringe or comparable device.

According to various embodiments, a method is provided comprising depositing reagent-containing, meltable beads into an array of wells in a substrate. In various embodiments, the beads can be meltable wax beads. After addition of the beads, the substrate can be oriented to allow gravity to position the beads in a desired location, for example, one that might otherwise be inaccessible by conventional liquid spotting methods. An otherwise inaccessible location can be, for example, an overhang above a narrow hole. In various embodiments, air, vacuum, or a sudden jerk can position the bead, and the substrate can then be heated to melt the bead and affix it to a specific surface or feature of the substrate.

According to various embodiments, the method can comprise creating hydrophobic barrier seals in an array of wells using paraffin, then centrifuging the paraffin and melting the paraffin to create a barrier at the intersection of a feed channel and the entrance to an individual well. In various embodiments, the wells can be covered, for example, by a cover film or by drops of oil. The drops of oil can be placed manually or can be preplaced as frozen pellets in the wells. Upon thawing of the frozen pellet, the liquid oil can cover the well and thus prevent evaporation of PCR reagents, other reagents and/or liquid in the well.

Without wishing to be held to any mechanism of action, a meltable bead can be attached to a specific surface or feature of the substrate in order to position dried reagents or melted beads such that a liquid sample could flow into a well in an array of connected wells without impinging on dried reagents in another well until, for example, the last moment in the process, at the earliest. At this point in the process, there can be no chance or no more than a minimal chance of a dissolved reagent in one well being carried into any of the other wells, thereby minimizing or eliminating false negative and/or false positive readings. In various embodiments, the probes can comprise nucleic acid sequences, for example, oligonucleotide primers. The nucleic acid sequences can comprise DNA sequences.

According to various embodiments, a method is provided that can comprise depositing at least one meltable reagent-containing bead into at least one well in an array of wells formed in a substrate, the wells communicating with one another through a channel network, the channel network adapted to prevent an aqueous solution from passing from the channel network into at least one of the wells of the array under a force required for loading an aqueous solution into the at least one well; sealing the wells; orienting the substrate such that the reagent-containing meltable bead moves to a desired location in the at least one well; and melting the bead to a surface of the at least one well after the bead has been moved to the desired location.

According to various embodiments, the meltable reagent-containing bead can comprise a meltable wax bead. In various embodiments, the at least one meltable reagent-containing bead can comprise at least two different meltable reagent-containing beads, the at least one well can comprise at least two wells, and the method can comprise depositing a different respective meltable reagent-containing bead in each of the at least two wells. In various embodiments, the at least one meltable reagent-containing bead can comprise one or more probes for nucleic acid analysis.

According to various embodiments, the method can comprise flowing a sample into a series of connected wells with different probes or reagents making it possible to create a relatively small integrated instrument that does not require a pipetting robot and that does not require depositing drops of sample into individual wells.

According to various embodiments, a method of distributing a liquid sample is presented that can comprise providing a fluid processing device, introducing a liquid sample into a feed channel of the fluid processing device, and spinning the fluid processing device to force a fluid or liquid from the feed channel into one or more of a plurality of through-holes of the fluid processing device. The fluid processing device can comprise a substrate. The substrate can comprise a first surface, an opposite second surface, a plurality of through-holes extending from the first surface to the second surface, a first side edge, a second side edge opposite the first side edge, and at the feed channel. The feed channel can comprise a zig-zag shape. The feed channel can comprise a plurality of peaks and a plurality of troughs. For each feed channel each respective peak can be closer to a first side edge than to a second side edge, each respective trough can be closer to the second side edge than to the first side edge, and each of the troughs can be in fluid communication with at least one respective through-hole of the plurality of through-holes, through a respective connecting channel. Each respective connecting channel can be adapted to prevent an aqueous solution from passing from the feed channel into the respective through-hole under a force required for loading an aqueous solution into the at least one feed channel.

According to various embodiments, the method can comprise additional manipulations, for example, covering a substrate with a cover layer, heating a liquid sample, detection of changes to a sample in the fluid processing device, fluorescence detection of a nucleic acid sequence disposed in a sample in the fluid processing device, and extracting or eluting a liquid comprising a nucleic acid sequence from the fluid processing device. Heating can comprise thermal-cycling, and thermal cycling can comprise polymerase chain reaction processing.

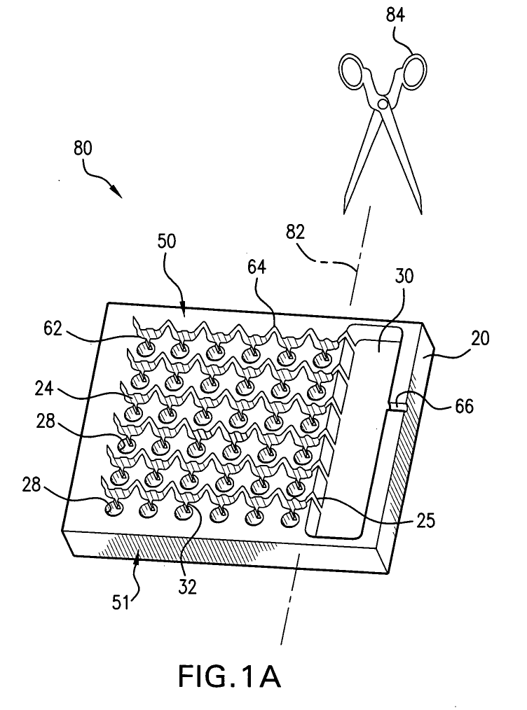

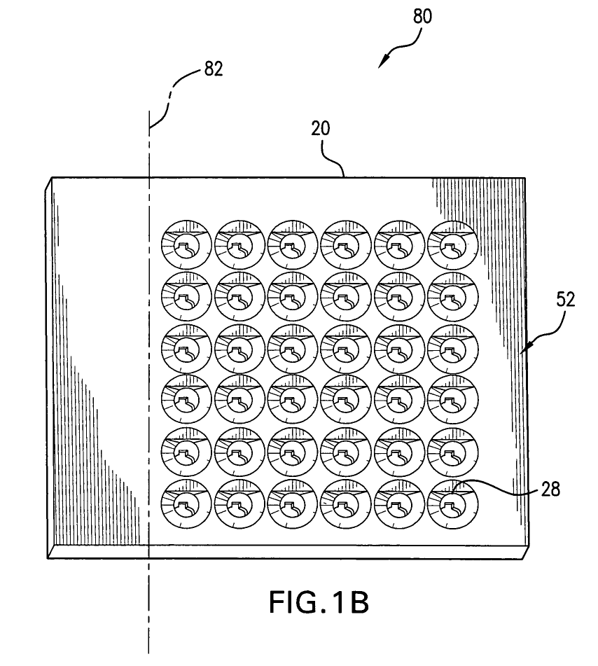

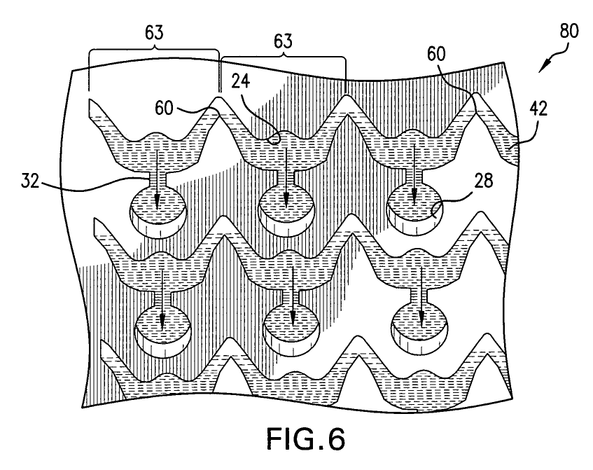

With reference now to the drawings, FIG. 1A, FIG. 1B, and FIG. 1C illustrate perspective views of two opposing surfaces of a fluid processing device 80. A substrate 20 can comprise a first surface 50 (see, FIG. 1A) and a second surface 52 (see, FIG. 1B). Fluid processing device 80 can comprise a feed or loading channel 24 disposed in or on first surface 50. A feed channel 24 can comprise a plurality of peaks 64. Feed channel 24 can comprise a plurality of troughs 62 (see, FIG. 2). Each peak 64 in feed channel 24 can be closer to a first side edge 53 (see, FIG. 7) than an adjacent trough 62 is to first side edge 53. Each trough 62 can be closer to a second side edge 51 than an adjacent peak is to second side edge 51. Each feed channel 24 can be in fluid communication with a reservoir 30 through a respective opening 25 connecting respective feed channel 24 to reservoir 30.

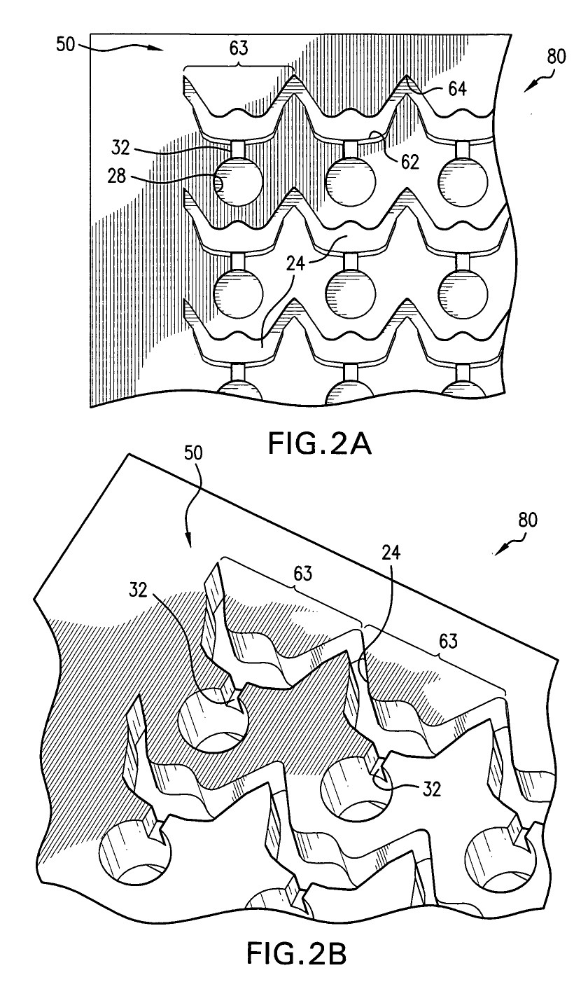

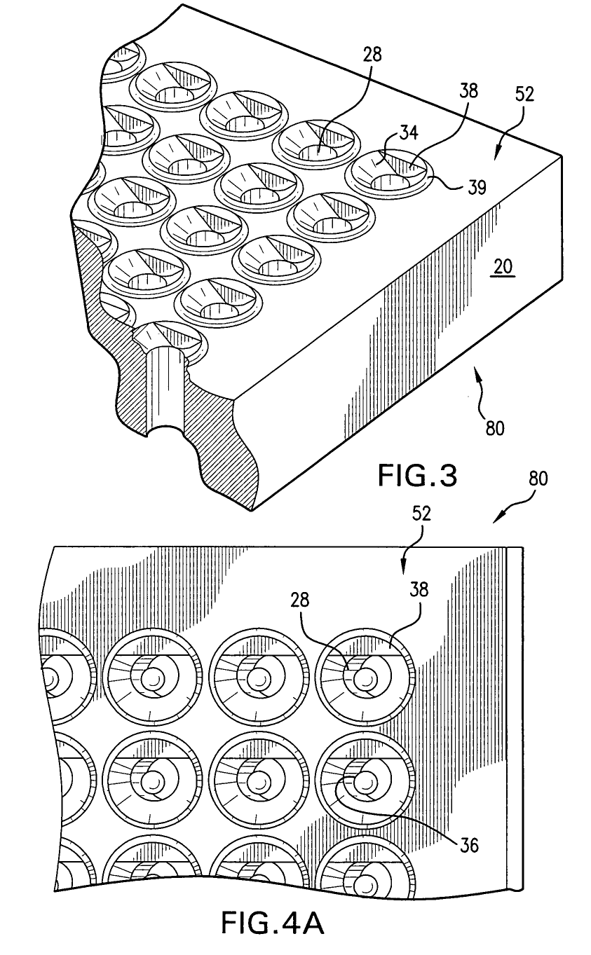

Trough 62 can be in fluid communication with at least one of a plurality of through-holes 28 through a connecting channel 32 as shown in greater detail in FIG. 2A. In various embodiments, connecting channel 32 can be adapted to prevent a liquid, for example, an aqueous solution, from passing from feed channel 24 into a respective through-hole 28 under a first force required for loading the liquid into feed channel 24. Each connecting channel 32 can be adapted to allow the liquid from passing from feed channel 32 into a respective through-hole under a second force. The second force can be greater than the first force. The second force can comprise a different vector component than the first force. For example, the first force can comprise capillary or gravity forces, and the second force can comprise centripetal or pneumatic forces. Connecting channel 32 can act as a lip or gate that can permit or restrict liquid flow from feed channel 24 to through-hole 28. As shown in FIGS. 1C, 2B, and 5, when a cover layer 40 covers first surface 50 of substrate 20, through-hole 28 can at least partially define a well when viewing the structure from the opposite side of the substrate (see, FIG. 4B). As shown in FIGS. 4B and 5, when a cover layer 41 covers second surface 52 of substrate 20, a well can be at least partially defined by through-hole 28 when viewing the structure from the opposite side of the substrate. When cover layer 40 and cover layer 41 are both disposed on fluid processing device 80, through-hole 28 can comprise a fluid retainment region protected from an ambient environment.

Referring to FIGS. 1A and 1C, reservoir 30 at one end of substrate 20 can be utilized to introduce a bulk sample. After each feed channel 24 is loaded, excess sample can remain in reservoir 30. According to various embodiments, capillary flow can be used to fill each feed channel 24 with a bulk sample disposed in reservoir 30. Alternatively, a pump, for example, an injection device or a fluid dispenser, can be used to fill each feed channel 24 from reservoir 30. A pump can be used to fill reservoir 30. The reservoir can comprise other cross-sectional shapes than rectangular. In various embodiments, reservoir 30 can be adapted to break away from the rest of substrate 20. Removing reservoir 30 from the rest of substrate 20 can allow matched coupling to another fluid-processing or analysis device. Fluid processing device 80 can comprise a cut-line 82 disposed in substrate 30. A cutting tool 84 can be used to remove reservoir 30 from substrate 20. In other embodiments, substrate 20 can be adapted to allow reservoir 30 to break off, for example, by bending substrate 20 along cut-line 82. Reservoir 30 can be in fluid communication with an inlet port 66. Inlet port 66 can be used for loading sample into reservoir 30 of the fluid processing device 80. Inlet port 66 can be positioned in fluid communication with a pump or other sample-providing device.

According to various embodiments, feed channel 24 can comprise a series of “V”-shaped or “U”-shaped sections. “V”-shaped or “U”-shaped sections are merely exemplary of configurations for each feed channel 24. Other configurations can be used. As shown, a plurality of feed channels 24 can be in fluid communication with reservoir 30, such that reservoir 30 acts as a manifold.

As seen in FIG. 5, details of the design for each through-hole 28 and the geometry of a respective connection to each feed channel 24 can prevent a respective portion of sample 42 from entering through-hole 28 as sample 42 flows through feed channel 24. A portion or segment 63 of feed channel 24 next to or adjacent each through-hole 28 can have an interior volume equal to or less than a total volume of through-hole 28. After feed channel 24 has been loaded with a sample 42, centrifugal or centripetal force can be used to overcome the forces inhibiting flow of sample 42 into through-holes 28 via connecting channel 32. Any air trapped in through-hole 28 can trade places with or be displaced by sample 42 in feed channel 24.

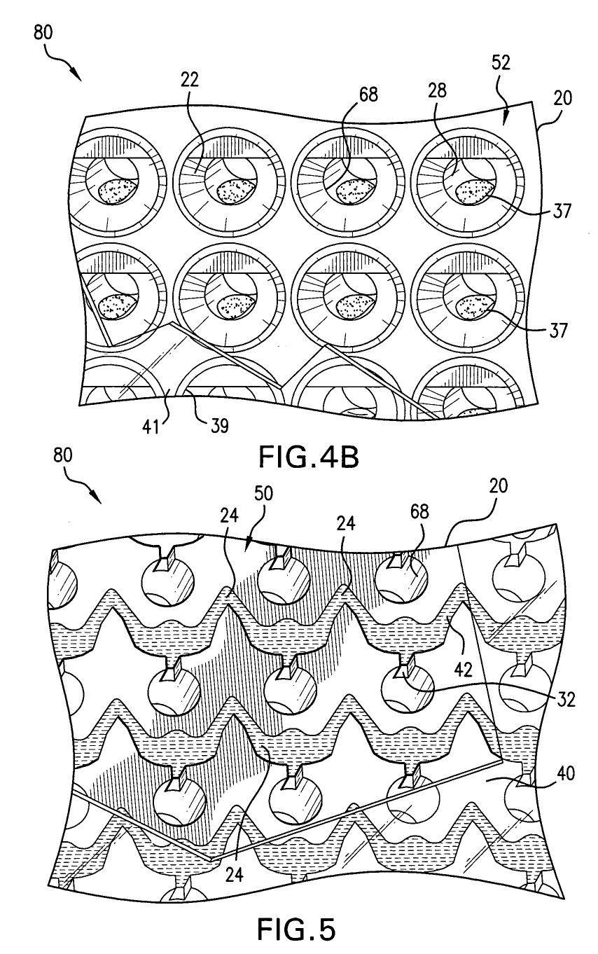

As seen in FIG. 6, as sample 42 starts to flow from feed channel 24 through connecting channel 32 and into through-holes 28, the top surface of sample 42 (relative to the direction of motion, for example, centrifugal motion) can fall below a plurality of points 60 in feed channel 24. Points 60 can isolate portions intended for respective through-holes 28 from adjacent portions of sample 42 intended for other through-holes. Two adjacent points 60 can define a segment 63. Even if a rate of flow of sample 42 from feed channel 24 to through-hole 28 varies for different respective through-hole 28 and connecting channel 32 pairs, the volume of the respective portion of sample 42 delivered to each through-hole 28 can be about the same. In some embodiments, a slight degree of uneven transfer can occur to the through-holes 28 before the respective portions of sample 42 fall below points 60 of feed channel 24.

According to various embodiments, before, during, and/or after the respective sample portions are delivered to the respective through-holes as shown in FIG. 7, substrate 20 can be configured to contact a thermal block or heater for thermally cycling biological materials disposed in through-holes 28, for example, when through-holes 28 form wells 22. Wells 22 can be formed from respective through-holes 28 when one or more cover layers (see, FIGS. 4B and 5) are disposed on either first surface 50 and/or second surface 52 of substrate 20. The thermal block can be operatively connected to a temperature control unit programmed to raise and lower the temperature of the thermal block according to a user-defined profile. For example, in various embodiments, a user can supply data defining time and temperature parameters of a desired PCR protocol to a control computer that causes a central processing unit (CPU) of the temperature control unit to control thermal cycling of the thermal block. In turn, the system can control the temperature of sample portions 42 disposed in fluid processing device 80. Several non-limiting examples of suitable temperature control units for raising and lowering the temperature of a sample block are described in U.S. Pat. No. 5,656,493 to Mullis et al. and U.S. Pat. No. 5,475,610 to Atwood et al., both of which are incorporated in their entireties herein by reference. Additional examples of thermal cyclers used in PCR reactions can include those described in U.S. Pat. No. 5,038,852 to Johnson et al. and U.S. Pat. No. 5,333,675 to Mullis et al., both of which are incorporated in their entireties herein by reference.

FIG. 1A illustrates an exemplary embodiment. Various embodiments can have fewer or greater numbers of through-holes 28, feed channels 24, reservoirs 30, or inlet ports 66. According to various embodiments, through-holes 28 in substrate 20 can be patterned to align with wells, openings, spacings, pipettors, injectors, or the like, on other fluid-processing devices, such that transfer of sample from the fluid processing device to another device for additional processing or analysis can be easily accomplished. In one example, the device can comprise eight feed channels with 12 through-holes in each such that an 8×12 array of 96 through-holes is provided, with each through-hole spaced 9.0 mm from adjacent through-holes.

According to various embodiments, substrate 20 can be a thin, flat rectangular plate. Substrate 20 can comprise a polymeric material, for example, substrate 20 can be molded of plastic or other polymers. Examples of polymers that can be used include polypropylene, polystyrene, polycarbonate, and copolymers thereof. In various embodiments, substrate 20 can comprise silicon or glass. Substrate 20 can comprise materials adapted to withstand forces applied to substrate 20. In the case of substrates like silica, glass or silicon, methods for etching, milling, drilling, or other methods known in the art, can be used to produce through-holes 28 and/or other features of fluid processing device 80 that make up the various regions, chambers, and fluid channels in substrate 20. In various embodiments, a polymeric substrate can be used that has been molded, etched, milled, drilled, laser-cut, or otherwise manipulated to produce desired features of the fluid processing device.

According to various embodiments, fluid processing device 80 can comprise a rectangular array of through-holes 28. Other shapes for an array of through-holes 28 can also be used. In various embodiments, a sample 42 can be directly pumped into one or more feed channel 24 such that reservoir 30 is not necessary.

FIG. 2A provides an enlarged top-plan view of a portion of first surface 50 of fluid processing device 80. Segment 63 of feed channel 24 can hold a volume of sample 42 intended to be loaded into a respective through-hole 28. Segment 63 can comprise a portion of feed channel 24 comprising one trough 62 bounded by two adjacent peaks 64. Without wishing to be held to a specific mechanism of action, connecting channel 32 can act as a gate such that sample 42 flows into through-hole 28 or well 22, for example, when fluid processing device 80 is spun in a centrifuge or some other appropriate manipulation is applied to the device and/or to the sample.

FIG. 2B provides an enlarged perspective view of fluid processing device 80. In various embodiments, connecting channels 32 can provide fluid communication between feed channel 24 and respective through-holes. Connecting channels 32 can have a shallower depth than a bottom of feed channel 24. In other embodiments, connecting channels 32 can each have a depth equal to the depth of feed channel 24. Each connecting channel 32 can have a depth that is less than the thickness of substrate 20.

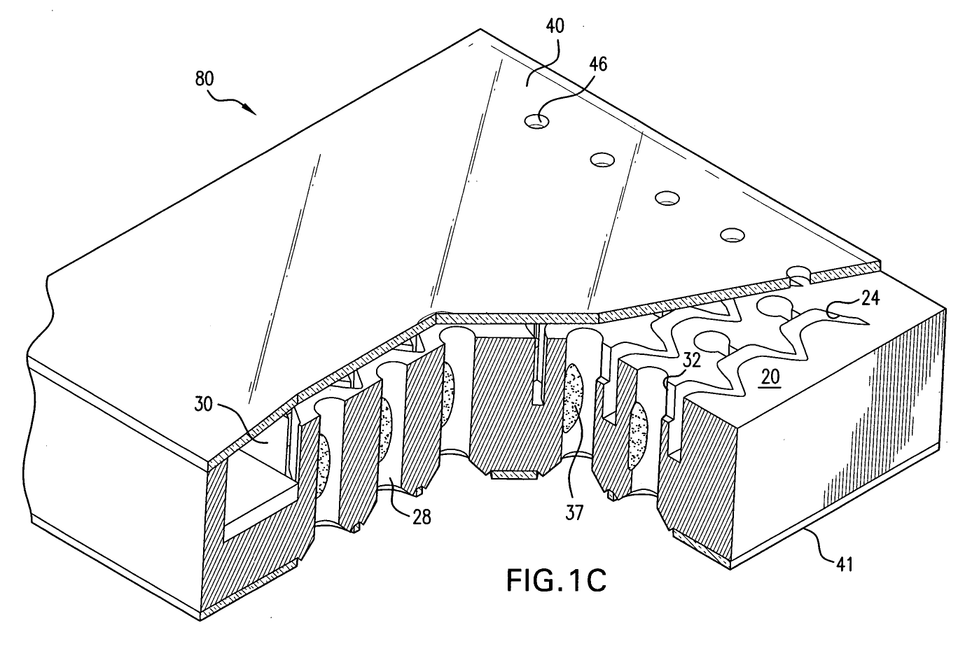

FIG. 3 is an enlarged perspective view of fluid processing device 80 illustrating second surface 52 of substrate 20. Through-hole 28 can comprise a tapered or conical entry 34, where through-hole 28 meets second surface 52. Tapered entry 34 can extend beyond second surface 52 to form a lip 39 adjacent through-hole 28. Lip 39 can comprise a conical outer surface extending to second surface 52. The conical outer surface of lip 39 can allow for a better fit and/or seal, for example, with wells of a multi-well plate (not shown) disposed against second surface 52. When a well of the multi-well plate is fitted against through-hole 28, contents of through-hole 28 can be transferred to the well of the multi-well plate, or vice-versa. Tapered entry 34 can comprise a non-tapered portion 38. Non-tapered portion 38 can provide a larger area of contact between a liquid reagent and a temperature-controlled surface, for example, a thermal block, that can drive temperature fluctuations involved in various reactions, for example, in a PCR. In various embodiments, non-tapered portion 38 of tapered entry 34 can eliminate a pocket in tapered entry 34 where air bubbles might be trapped during centrifugation of fluid processing device 80.

With reference to FIG. 4B, according to various embodiments, well 22 can comprise a set of reagents, for example, reagents that can act as detectors for a specific DNA sequence. Such reagents can be introduced by dispensing a liquid solution into each well 22. The liquid solution can then be dried down to leave behind a dried patch of reagents in well 22 where the liquid solution was introduced. According to various embodiments, and as seen in FIG. 4A, such reagents can be introduced as a bead 36 into through-hole 28. Bead 36 can comprise a wax-like water soluble material, for example, polyethylene glycol (PEG). Bead 36 can be loaded into a well 22 comprising through-hole 28 sealed at first surface 50 and/or at a second surface 52. Through-hole 28 can have a tapered shape, for example, narrower end of a taper towards first surface 50, wherein the tapered shaped has a cross-sectional area smaller than a maximum cross-sectional area of a liquid drop to be introduced into the through-hole. A smaller sized through-hole 28 near first surface 50 can leave more room on first surface 50 for feed channels 24. In other embodiments, through-holes 28 can comprise a cylindrical shape.

According to various embodiments, and as seen in FIG. 4B, through-hole 28 can be sealed by disposing cover layer 41 on second surface 52. After sealing through-hole 28, bead 36 can be melted using a thermocycler, for example. When melting bead 36, fluid processing device 80 can be held in any orientation while heat is applied. This can result in bead 36 being melted to side wall 68 of through-hole 28, at non-tapered portion 38 or elsewhere in through-hole 28. The melting can transform bead 36 into a dried or hardened reagent patch 37. Bead 36 can melt or adhere to a specific portion of side wall 68. Prior to melting, bead 36 can be placed by orienting substrate 20 such that, for example, there is a reduced chance of contact between a liquid sample and bead 36 before a sample loading process has progressed to a point where cross-contamination is no longer an issue.

Formulation of beads 36 can be readily determined by one of skill in the art. The formulation can depend upon a desired application of the fluid processing device. Bead 36 can comprise a material that has a melting point, for example, above about 25° C., from about 35° C. to about 100° C., from about 40° C. to about 70° C., from about 50° C. to about 80° C., or from about 50° C. to about 100° C.

Beads 36 can comprise reagents, for example, enzymes or other reagents, that can be heat-resistant at a melting temperature of bead 36. After a melting of bead 36, reagents contained therein can then be released into a solution at a desired melting temperature.

According to various embodiments, reagents that can be included in bead 36 can comprise buffers, for example, saline, TRIS, acids, bases, detergents, or other components commonly used for DNA and RNA reactions, purification, and/or washing. Reagents, dried in through-hole 28 or comprising a bead 36, can be employed as precursor materials for reconstitution and solution-phase interactions or as solid-phase reagents. Beads 36 can comprise: pH indicators; redox indicators; enzymes, for example, horseradish peroxidase, alkaline phosphatase, reverse transciptase, DNA polymerase, and restriction enzymes; enzyme substrates; enzyme-antibody or enzyme-antigen conjugates; DNA primers and probes; buffer salts; and detergents. Solid-phase reagent coatings, for example, serum albumin, streptavidin, and a variety of cross-linkable proteins such as polysaccharides, can be included in beads 36. It is to be understood that the foregoing are merely examples of reagents that can be used in bead 36 and are in no way limiting as to other reagents. In various embodiments, each through-hole 28 can comprise a unique set of reagents that can act as a detector for an analyte of interest, for example, a specific DNA sequence.

According to various embodiments, bead 36 can comprise a substituted polyethylene glycol material. An exemplary substituted polyethylene glycol can comprise poly (ethylene glycol) methyl ether. Bead 36 can alternatively comprise a polyethylene glycol derivative. An exemplary polyethylene glycol derivative can comprise a triblock copolymer of polyethylene oxide and polypropylene oxide.

Bead 36 can comprise a branched polyethylene glycol or derivative thereof. Exemplary substituted polyethylene glycol materials are shown in Table 1 below. According to various embodiments, bead 36 can comprise reagents such that the reagents are within a hollow center of bead 36. According to other embodiments, a substance for forming the beads can be intermingled or complexed into a mixture which is then formed into the beads. Reagent beads 36 can be obtained by injecting reagents into a bead or dipping liquid droplets into molten material to coat the material. Additional guidance for making such beads can be found, for example, in U.S. Pat. No. 5,643,764, incorporated herein in its entirety by reference.

According to various embodiments, each reagent bead 36 can be used in a nucleic acid hybridization, polymerase chain reaction, reverse transcriptase reaction, nucleic acid sequencing, and/or nucleic acid product-generating reaction. Product-generating reactions can comprise calorimetric, fluorometric and chemiluminescent enzyme labeled assays. According to various embodiments, it can be desirable for bead 36 to melt and release its contents at high temperatures, for example, at from about 50° C. to about 100° C., while in other embodiments lower melting temperatures can be desirable, for example, about 30° C. to about 50° C.

TABLE 1
Examples for Substituted Poly(ethylene glycol)s

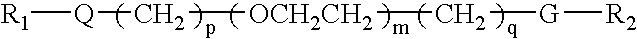

| | Trade | | | | | | | | | mp | ca. | | |
|---|---|---|---|---|---|---|---|---|---|---|---|---|---|
| # | Name | Chemical Name | R₁ | R₂ | G | Q | m | p | q | (° C.) | Mₙ (Da) | HLB | Supplier |
| 1 | Brij ® | poly(ethyleneglycol) | C₁₆H₃₃ | H | O | O | — | zero | zero | 32-34 | 683 | 12.9 | ICI |
| | 56 | cetyl ether | | | | | | | | | | | Americas, |
| | | | | | | | | | | | | | Norwich, |
| | | | | | | | | | | | | | NY |
| 2 | Brij ® | poly(ethyleneglycol) | C₁₆H₃₃ | H | O | O | — | zero | zero | 38-43 | 1124 | 15.7 | ICI |
| | 58 | cetyl ether | | | | | | | | | | | Americas, |
| | | | | | | | | | | | | | Norwich, |
| | | | | | | | | | | | | | NY |
| 3 | Brij ® | poly(ethyleneglycol) | C₁₈H₃₇ | H | O | O | — | zero | zero | 37-39 | 711 | 12.4 | ICI |
| | 76 | stearyl ether | | | | | | | | | | | Americas, |
| | | | | | | | | | | | | | Norwich, |
| | | | | | | | | | | | | | NY |
| 4 | Brij ® | poly(ethyleneglycol) | C₁₈H₃₇ | H | O | O | — | zero | zero | 44-46 | 1152 | 15.3 | ICI |
| | 78 | stearyl ether | | | | | | | | | | | Americas, |
| | | | | | | | | | | | | | Norwich, |
| | | | | | | | | | | | | | NY |
| 5 | Brij ® | poly(ethyleneglycol) | C₁₈H₃₇ | H | O | O | — | zero | zero | 51-54 | 4670 | 18.8 | ICI |
| | 700 | stearyl ether | | | | | | | | | | | Americas, |
| | | | | | | | | | | | | | Norwich, |
| | | | | | | | | | | | | | NY |
| 6 | — | Poly(ethylene glycol) | C₁₇H₃₅CO | OCC₁₇H₃₅ | O | O | — | 2 | 2 | 35-37 | 930 | — | Aldrich |
| | | disterate | | | | | | | | | | | Chemical, |
| | | | | | | | | | | | | | Milwaukee, |
| | | | | | | | | | | | | | WI |
| 7 | — | Poly(ethylene glycol) | C₁₇H₃₅CO | OCC₁₇H₃₅ | O | O | — | 2 | 2 | 52-57 | 12500 | — | Polysciences, |
| | | disterate | | | | | | | | | | | Warrington, |
| | | | | | | | | | | | | | PA |
| 8 | — | Poly(ethylene glycol) | H₂N(CH₂)₃ | H₂N(CH₂)₃ | O | single | ˜34 | zero | zero | 49 | — | — | Aldrich |
| | | bis(3-aminopropyl) ether | | | | bond | | | | | | | Chemical, |
| | | | | | | | | | | | | | Milwaukee, |
| | | | | | | | | | | | | | WI |
| 9 | — | Poly(ethylene glycol) | HO₂CCH₂ | CH₂CO₂H | O | single | — | zero | zero | — | 600 | — | Aldrich |
| | | bis(carboxymethyl) ether | | | | bond | | | | | | | Chemical, |
| | | | | | | | | | | | | | Milwaukee, |
| | | | | | | | | | | | | | WI |
| 10 | — | Poly(ethylene glycol) | CH₃ | H | O | O | — | zero | zero | 20 | 550 | — | Aldrich |
| | | methyl ether | | | | | | | | | | | Chemical, |
| | | | | | | | | | | | | | Milwaukee, |
| | | | | | | | | | | | | | WI |
| 11 | — | Poly(ethylene glycol) | CH₃ | H | O | O | — | zero | zero | 30 | 750 | — | Aldrich |
| | | methyl ether | | | | | | | | | | | Chemical, |
| | | | | | | | | | | | | | Milwaukee, |
| | | | | | | | | | | | | | WI |
| 12 | — | Poly(ethylene glycol) | CH₃ | H | O | O | — | zero | zero | 52 | 2000 | — | Aldrich |
| | | methyl ether | | | | | | | | | | | Chemical, |
| | | | | | | | | | | | | | Milwaukee, |
| | | | | | | | | | | | | | WI |
| 13 | — | Poly(ethylene glycol) | CH₃ | H | O | O | — | zero | zero | 59 | 5000 | — | Aldrich |
| | | methyl ether | | | | | | | | | | | Chemical, |
| | | | | | | | | | | | | | Milwaukee, |
| | | | | | | | | | | | | | WI |
| 14 | — | Poly(ethylene glycol) | CH₃ | CH₃ | O | O | — | zero | zero | 42 | 1000 | — | Aldrich |
| | | methyl ether | | | | | | | | | | | Chemical, |
| | | | | | | | | | | | | | Milwaukee, |
| | | | | | | | | | | | | | WI |

Exemplary derivatives of PEG that can be used include, for example, those shown in Table 2 below:

TABLE 2
Derivatives of PEG*

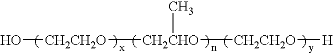

| | Average | | |
|---|---|---|---|
| | Molecular | Melting Pt | |
| Trade name | Weight | (° C.) | HLB |
| Pluronic ® F38 | 4700 | 48 | >24 |
| Pluronic ® F77 | 6600 | 48 | >24 |
| Pluronic ® F87 | 7700 | 49 | >24 |
| Pluronic ® F68 | 8400 | 52 | >24 |
| Pluronic ® F88 | 11400 | 54 | >24 |
| Pluronic ® F127 | 12600 | 56 | 18-23 |
| Pluronic ® F108 | 14600 | 57 | >24 |
| Pluronic ® F98 | 13000 | 58 | >24 |

*Triblock copolymers of PEO and PPO (BASF, Mount Olive, NJ)

According to various embodiments, a variety of substances can be used for preparation of beads 36 including wax or wax-like polymers that are solid or semi-solid at room temperature, but can be melted above room temperature to form a dispersible liquid. Waxy polymers can comprise any naturally occurring or synthetic waxes, or wax esters that have a desired melting temperature or range and are suitably inert for use in the reaction.

Examples of suitable waxes and greases that can be used to make beads as described herein, esters of various long-chain (fatty) alcohols and long-chain acids, an ester comprising 10 or more carbon atoms, various unsaturated and branched chain esters, and esters of glycerols and sterols.

According to various embodiments, the beads can comprise free alcohols or acids having even or odd numbers of carbons and/or wax-like properties of melting temperature and inertness. Some examples of saturated fatty acids and their corresponding approximate melting points or ranges include capric acid (about 31.3° C.), lauric acid (about 48° C.), myristic acid (about 58° C.), palmitic acid (from about 63° C. to about 64° C.), margaric acid (about 59.3° C.), stearic acid (from about 70.5° to about 71.5° C.), arachidic acid (from about 76° to about 77° C.), behenic acid (from about 81° to about 82° C.), tetracosanic acid (from about 84.5° to about 85.5° C.), lignoceric acid (from about 75° to about 80° C.), cerotic acid (about 78° C.), and melissic acid (about 91° C.). Some examples of unsaturated fatty acids and their corresponding approximate melting points or ranges include tiglic acid (from about 64° to about 65° C.), hypogaeic acid (from about 33° to about 49° C.), gaidic acid (about 39° C.), physetoleic acid (about 30° C.), elaidic acid (from about 44° to about 45° C.), oleic acid (from about 58° to about 59° C.), isooleic acid (from about 44° to about 45° C.), erudic acid (from about 33° to about 34° C.), brassidic acid (about 65° C.), and isoerudic acid (from about 54° to about 56° C.). Other various esters that can be used include those of other fatty acids with any suitable fatty alcohol, or with any suitable sterol, such as cholesterol, or glycerol. Some examples of fatty alcohols and their corresponding approximate melting points or ranges include octadecyl alcohol (about 59° C.), carnaubyl alcohol (from about 68° to about 69° C.), ceryl alcohol (about 80° C.), and melissyl alcohol (about 88° C.).

According to various embodiments, beads 36 can comprise one or more of RNA, DNA, labeled or unlabeled oligonucleotides for use as hybridization probes or primers. For use in PCR, the beads 36 can comprise one or more appropriate antisense (reverse) primers and sense (forward) primers, for example, those labeled with any suitable label such as biotin, digoxigenin, sulfur, cyclodextrins, fluorophores, isotopes, and proteins. According to various embodiments, beads 36 can comprise one or more reaction components labeled with a radioactive nuclide such as H³, C¹⁴, p³², S³⁵, and I¹²⁵. Additional description of reaction components can be found in U.S. Patent Application No. 60/619,623, filed Oct. 18, 2004, which is incorporated herein in its entirety by reference.

With reference to FIG. 4A, an enlarged bottom perspective view is shown of fluid processing device 80 comprising a bead 36 disposed in through-hole 28. Cover layer 40 (FIG. 5) can be disposed on the opposite side of the device such that through-hole 28 can have a closed end. Bead 36 can be disposed in through-hole 28 before a cover layer is disposed on second surface 52 and/or before a cover layer is disposed on first surface 50. Fluid communication between through-hole 28 and feed channel 24 can be small enough so that bead 36 cannot escape through-hole 28 and enter feed channel 24. Each bead 36 can be spherical and connecting channel 32 can have a maximum opening cross-sectional dimension that is less than the diameter of bead 36. According to various embodiments, instead of one bead, bead 36 can comprise a plurality of beads. In various embodiments, a plurality of beads can be disposed in a respective through-hole 28 and each can comprise a different reagent. For example, each through-hole 28 can contain a plurality of primer beads wherein all the primer beads comprise the same primer, or each through-hole 28 can comprise a different type of bead compared to the beads in the different through-holes. For example, each through-hole 28 can comprise a zip-code primer bead that is different than the zip-code primer beads in the other through-holes 28 of fluid processing device 80. In other embodiments, the plurality of beads in one through-hole 28 can provide a larger quantity of the same reaction component when compared to the amount in one or more other through-holes 28.

FIG. 4B illustrates deformed beads 37 that have been melted against side wall 68 of through-hole 28. Cover layer 41 disposed on second surface 52 has been partially cutaway. Cover layer 41 can be sealed to second surface 52 to prevent liquid from escaping from through-hole 28. Cover layer 41 can be disposed on second surface 52 before or after the bead 36 is melted. Cover layer 41 can be attached to second surface 52 of substrate 20 before or after reagents are added to through-hole 28. Cover layer 41 can comprise a transparent film or another material capable of preventing liquid from escaping from through-hole 28. As shown in FIG. 5, attaching cover layer 40 to first surface 50 of substrate 20 can be one of the last things done in constructing fluid processing device 80. Attachment of cover layer 40 and cover layer 41 to the opposing surfaces of substrate 20, and disposition of beads, can be performed by a manufacturer or user. If accomplished by the manufacturer, a user may then need only add a liquid sample prior to processing a sample in the fluid processing device. The cover layer can be attached to substrate 20 during manufacture by any number of conventional technologies, for example, adhesive attachment, heat sealing, solvent sealing, chemical bonding, or ultrasonic welding.

FIG. 5 is an enlarged top view of fluid processing device 80 after a sample 42 has been pumped, drawn by capillary force, spun, or otherwise moved into feed channel 24. Sample 42 may not pass through connecting channel 32 to through-hole 28 until application of a force to fluid processing device 80. Without being bound to any specific mechanism of action, this may be due to the shape of fluid communication 32, an air bubble that can be trapped by through-hole 28, and/or a degree of hydrophobicity on the surfaces of feed channel 24. If surfaces of feed channel 24 are hydrophobic, intrusion of sample 42 into connecting channel 32 can be more easily prevented than if the surfaces are not hydrophobic. According to some embodiments, sample 42 can be pumped into channel 24.

According to various embodiments, hydrophobic materials that can be used as substrate 20 can include, but are not limited to, plastic materials. According to various embodiments, the substrate 20 can comprise a hydrophilic material.

FIG. 6 illustrates portions of sample 42 entering respective through-holes 28 through respective connecting channels 32. Sample 42 can be disposed in feed channels 24 and air in through-holes 28 can travel toward the respective feed channels 24 through the respective connecting channels 32. As sample 42 is transferred, the level of sample 42 in feed channel 24 can drop below a point 60 in feed channel 24. Any sample 42 below point 60 cannot flow between adjacent segments 63 of feed channel 24. After sample 42 recedes to below point 60, any variation in a flow rate into the respective through-hole 28 of a first segment 63, as compared to the flow rates into the through-holes of other segments 63, will not effect the volume of sample 42 transferred into each through-hole 28. This segmentation of sample 42 into distinct or discreet volumes, can prevent uneven distribution of sample 42.

FIG. 7 illustrates a manner in which sample 42 can eventually end up in through-holes 28 and their corresponding wells 22 after leaving feed channel 24. As shown, after such transfer, the feed channels 24 can contain air. At this point, fluid processing device 80 can be ready to be utilized, for example, for performing PCR tests, other DNA-based analysis, or any other desired biochemical reaction. A respective vent 46 through cover layer 40 can be provided at an end of each feed channel 24, opposite opening 25 of a respective feed channel 24 (see, FIG. 1A). Each vent 46 can allow escape of gases during sample preparation. In some embodiments, there can be some evaporation into feed channels 24 from features of fluid processing device 80, but the evaporation can be self-limiting if each vent 46 is covered or blocked. Each vent 46 in cover layers 40 and/or 41 can be clamped off or covered to prevent evaporation, for example, prior to heating or storing a loaded fluid processing device.

According to various embodiments, rather than utilizing vent 46 in fluid processing device 80, gases can escape through one or more of cover layers 40 and 41. The cover layer can comprise a material having a property that can allow gas to pass readily, but still provides a strong barrier to liquids, for example, aqueous liquids, at least under atmospheric pressure. In this way, there can be a discrimination made between liquids and gases without the need for a valve or vent.

A barrier to passage of liquids can be achieved in several ways known to one of skill in the art, for example, as described in U.S. Pat. No. 5,589,350, which is incorporated herein in its entirety by reference. One or more cover layers can be provided that are hydrophobic and porous. According to various embodiments, one or more of the cover layers can be adapted to swell and close off pores when contacted by a liquid, or one or more of the cover layers can be adapted to form a film or gel that would effectively plug or close pores therein upon contact with a liquid. By incorporating one of such venting materials into the fluid processing device, gases can be allowed to escape from the fluid processing device during filling, while preventing the escape of liquid sample. Such a fluid flow discriminator can operate, without any moving parts. Exemplary materials that can be used, for such cover layers, can include, but are not limited to, for example, polydimethylsiloxane (PDMS), polyvanilidine chloride (PVDC), polyvanilidine difluoride (PVDF) and polytetrafluoroethylene (PTFE). Exemplary PDMS materials include those described in U.S. patent application Ser. No. 10/762,786, filed Jan. 22, 2004, which is incorporated herein in its entirety by reference.

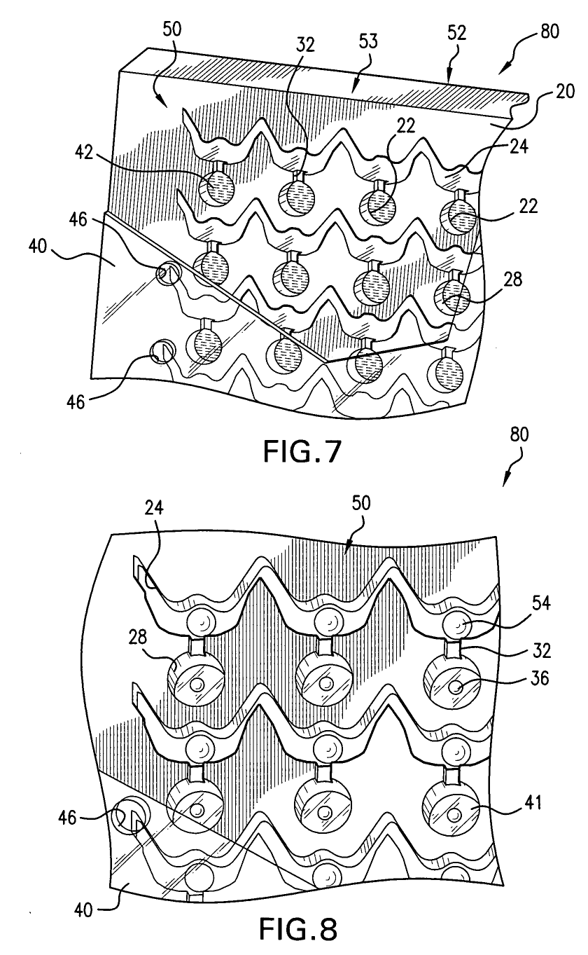

According to various embodiments, a plug of insoluble wax, for example, a wax plug 54 (see, FIG. 8), for example, comprising paraffin, can be positioned next to connecting channel 32. Fluid processing device 80 can then be heated to a temperature that is above the melting point of wax plug 54 while fluid processing device 80 is spinning. Wax plug 54 can have a lower density than that of sample 42. Wax plug 54 can be adapted to flow into connecting channel 32 or stay in feed channel 24, adjacent an opening of connecting channel 32, whereby, upon melting, wax plug 54 can seal connecting channel 32. In some embodiments, wax plug 54 can be re-melted during a procedure or during a cycle. When re-melted, wax plug 54 can act like an oil and stay on top of sample 42, when a material for wax plug 54 is used that has a lower density than sample 42. In other embodiments, oil can be disposed in each feed channel 24 after the portions of sample 42 have been transferred to the respective through-holes 28, for example, such that the oil can seal each through-hole 28.

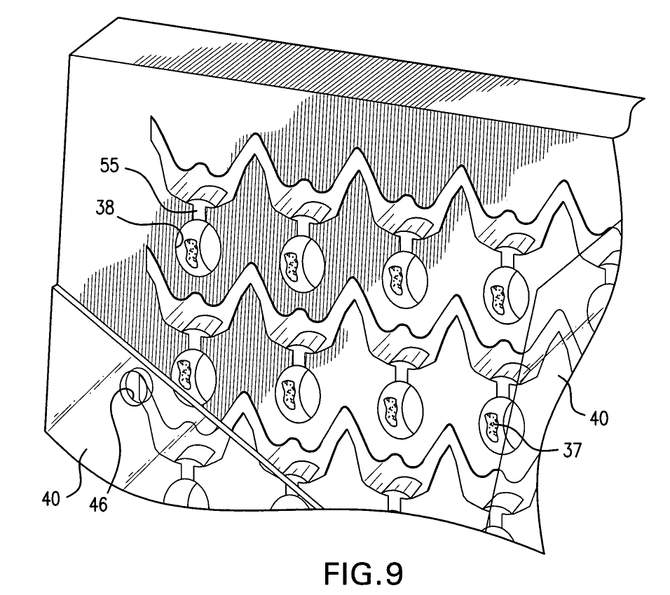

As shown in FIGS. 8 and 9, each wax plug 54 can be deposited in a respective feed channel 24 adjacent a respective connecting channel 32. Each wax plug 54 can then be melted and centrifugal force can then be used to cause the melted wax plug to flow into connecting channel 32, forming a plug 55 that blocks or caps the respective connecting channel 32.

Examples of paraffins that can be used in the manufacture of plugs 54, and their corresponding melting points (m.p.), are: hexacosane (about 56.4° C.), hentriacosane (about 59° C.), octacosane (about 61.4° C.), nonacosane (about 62.7° C.), triacontane (about 65.6° C.), hentriacontane (about 67.6° C.), dotriacontane (about 69.5° C.), tetratriacontane (about 72.5° C.), pentatriacontane (about 74.4° C.), and hexatriacontane (about 75.7° C.).

According to various embodiments, exemplary paraffin waxes that can be used include, but are not limited to those having melting points of from about 44° C. to about 46° C., from about 50° C. to about 52° C., from about 54° C. to about 56° C., from about 58° C. to about 60° C., and from about 68° C. to about 74° C., for example, those available from Fluka Chemical Corp., St. Louis, Mo. Depending on the desired properties, such as melting point, inertness, solubility, and buoyancy, any of the waxy polymers described herein can be combined in various proportions to give a desired result. Useful waxy polymers can also include any suitable long-chain hydrocarbon or ester mentioned previously that has been suitably derivatized to give it neutral buoyancy in an aqueous medium. For example, a long-chain hydrocarbon or ester can be suitably chlorinated or fluorinated to make it less buoyant. The shaft can be inserted into a base 102 that can comprise a drive unit for spinning the platen.

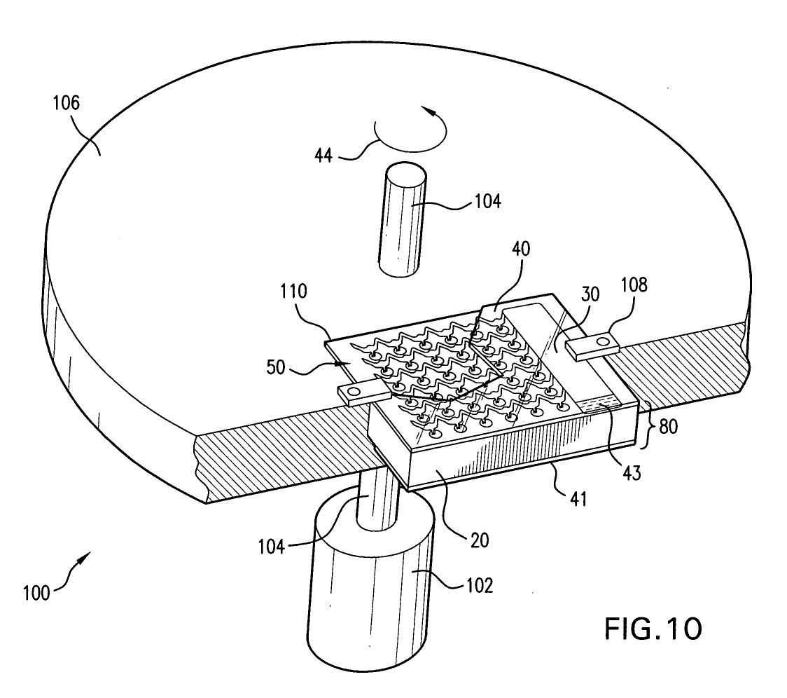

FIG. 10 is a perspective view of fluid processing system 100 comprising a rotatable platen 106 adapted to be spun by a shaft 104 about an axis of rotation in direction 44. Fluid processing device 80 can be spun with rotatable platen 106 by a drive unit 102 to force sample from feed channel into the respective through-holes. Cover layers 40 and 41 can cover substrate 20 on the first and second surfaces, respectively, of substrate 20. Excess sample 43 can be left in reservoir 30 after fluid processing device 80 is spun. Fluid processing device 80 can be disposed in a fluid processing device holder 110, for example, comprising a recessing rotatable platen 106. Fluid processing device 80 can be held by one or more tabs 108 on platen 106. Tabs 108 can comprise, for example, a pivoting lock-tab or lever, or any means known in the art for securing a device to a rotatable platen.

A fluid processing device holder for holding a fluid processing device in or on a platen can be formed using various methods and/or apparatuses. The fluid processing device holder can comprise a recess in the platen in which a fluid processing device can be placed. According to various embodiments, the fluid processing device holder can comprise a pin and hole combination, a pin and notch combination, clips, swing arms, screws, VELCRO™, snaps, straps, tape, adhesive, other fasteners, a door, or a combination thereof, to hold the fluid processing device in or on a rotatable platen.

According to various embodiments, a fluid processing device can be fixedly attached to the fluid processing system or the fluid processing device can be separate from the fluid processing system. If separate, the fluid processing device can be removably attached to or brought into contact with the fluid processing system in a manner that facilitates removal from the fluid processing system without significant destruction of the fluid processing device.

According to various embodiments, a method of distributing a liquid sample into a plurality of through-holes in a fluid processing device is provided that can comprise providing a fluid processing device, introducing a liquid sample into a feed channel of the fluid processing device, and centrifugally spinning the fluid processing device to force fluid from the feed channel into one or more of a plurality of through-holes of the fluid processing device. The fluid processing device can be part of a sample processing system that includes a rotatable platen and the fluid processing device held therein and/or thereon.

According to various embodiments, the method can comprise thermally processing a sample. “Thermal processing” (and variations thereof) can refer to controlling (e.g., maintaining, raising, or lowering) the temperature of sample materials to obtain desired reactions or perform other chemical or molecular biological manipulation. As one form of thermal processing, “thermal cycling” (and variations thereof) would be understood by one of skill in the art as sequentially changing the temperature of sample materials between two or more temperature setpoints to obtain desired reactions. In some embodiments, thermal cycling can comprise, cycling between a lower and an upper temperature or cycling between a lower, an upper, and at least one intermediate temperature.

The fluid processing device can be a liquid vessel, for example, a tray configured as a micro-titer tray. The fluid processing device can have a plurality of through-holes, fluid retainment regions, wells, chambers, vessels, or the like, formed therein, for example, 12, 24, 48, 96, 192, 384, 768, 1536, 3072, 6144, or more, through-holes.

According to various embodiments, a method of manufacturing a fluid processing device is provided. The method can comprise providing a substrate with through-holes and a feed channel. The method can comprise sealing the second surface of the fluid processing device using a cover layer. The sealing of cover layer to second layer can fuse or integrate the cover layer and the substrate. The fused cover layer and substrate can provide a smooth surface, as the cover layer can deform to flow and smooth out lip 39 of through-hole 28 (see, FIG. 4B).

Beads comprising reagents can be placed in the through-holes using a robotic or manual bead dispenser. Robotic systems for dispensing beads in a multi-well array are disclosed, for example, in U.S. patent application Ser. No. 10/946,718 filed Sep. 22, 2004, which is incorporated herein in its entirety by reference.

According to various embodiments, the robotic system can individually handle a single particle or bead having an average diameter of, for example, from about one nanometer to about one centimeter, or from about 10 microns to about 2000 microns, or from about 50 microns to about 1000 microns, or from about 100 microns to about 200 microns. According to various embodiments, each bead can have an average diameter of about 1.0 mm or less. The robotic system can comprise a robot, for example, a storage and retrieval robot. The robot can comprise a positioning robot, for example, as known to those skilled in the art. The teachings of International Publications Nos.: WO 00/49382, international filing date Feb. 15, 2000; WO 00/48735, international filing date Feb. 15, 2000; and WO 03/022437 A1, international filing date Sep. 9, 2002, are all incorporated herein in their entireties by reference. The robotic system can comprise a robot, for example, as described in Noda et al., “Automated Bead Alignment Apparatus Using a Single Bead Capturing Technique for Fabrication of a Miniaturized Bead-Based DNA Probe Array,” Analytical Chemistry, Vol. 75, No. 13, Jul. 1, 2003, in U.S. patent application Ser. No. 09/506,870, filed Feb. 15, 2000, and in U.S. patent application Ser. No. 10/211,131, filed Aug. 2, 2002, all of which are incorporated herein in their entireties by reference.

According to various embodiments, once the reagent beads have been dispensed in through-holes 28, the fluid processing device can be heated to melt the beads. The heating can be done by contact of the substrate with a radiant heater, using a non-contact radiant heater, using an oven, using a microwave oven, or using any other heating method known in the art. Heating the fluid processing device can cause the reagents in the beads to melt onto a sidewall or on a surface of the cover layer 41 at through-hole 28.

According to various embodiments, a bead or paraffin wax can then be dispensed in feed channel 24 adjacent connecting channel 32. The dispensing of the paraffin wax can comprise using a spraying mechanism, for example, an inkjet printer head, wherein heated wax is applied to a cold substrate. When the heated wax comes in contact with a cool substrate, the wax can become affixed to the substrate wall on contact. This can prevent movement of the wax. The quantity of wax applied to each feed channel 24 adjacent each connecting channel 32 can be sufficient to dam connecting channel 32 upon a second or further heating of fluid processing device. According to various embodiments, at this time, the wax is not dispensed in a manner to block connecting channel 32. After the dispensing of the wax into the feed channels is complete, cover layer 40 can be applied to substrate 20 on first surface 50. This can complete the manufacture of the fluid processing device. The fluid processing device can then, for example, be sealed, packaged, and shipped to a user.

In various embodiments, a user can use the fluid processing device to perform a plurality of assays and/or reactions. The fluid processing device can comprise all the reagents needed for an assay or a reaction. Reagents can be supplemented using methods of loading described in the teachings of the present application. In other embodiments, all that is necessary to begin testing a sample is to load the fluid processing device using the reservoir and/or input port. Once a feed channel has been loaded and the fluid processing device has been closed, for example, by closing any vents or input ports, the fluid processing device can be dispensed in a centrifuge capable of providing non-contact heating to the substrate. The heat and spin provided by the centrifuge can first melt the wax and then allow the melted wax to flow into the connecting channel. If the wax passes through the connecting channel into through-hole, there can still be reactions in through-hole 28, so long as the wax does not interfere with the desired reaction in through-hole 28. The wax can act as a barrier for any steam or gases that might otherwise escape from the through-hole.

When centrifuging, the fluid processing device can be disposed in the centrifuge such that a through-hole is radially further from the center of the axis of rotation than the segment of the feed channel in fluid communication with the through-hole. When orientated in such a manner, the centripetal force created by spinning the fluid processing device can force liquids from the respective segment into the respective through-hole. This can trap the sample and the reagent in the through-hole.

Other embodiments of the present teachings will be apparent to those skilled in the art from consideration of the present specification and practice of the present teachings disclosed herein. It is intended that the present specification and examples be considered as exemplary.

What is claimed is:

1. A fluid processing device comprising:
a substrate comprising a first surface, an opposite second surface, a plurality of through-holes extending from the first surface to the second surface, a first side, a second side opposite the first side edge, and at least one feed channel, the at least one feed channel comprising a zig-zag shape and including a plurality of peaks and a plurality of troughs, wherein each of the peaks is closer to the first side edge than its corresponding trough is to the first side edge, each of the troughs is closer to the second side edge than its corresponding peak is to the second side edge, and each of the troughs is in fluid communication with at least one of the plurality of through-holes through a respective fluid communication, wherein each respective fluid communication is adapted to prevent an aqueous solution from passing from the at least one feed channel into the respective at least one through-hole under a force required for loading an aqueous solution into the at least one feed channel.

2. The fluid processing device of claim 1, further comprising a cover layer attached to one or more of the first surface and the second surface.

3. The fluid processing device of claim 1, wherein the substrate is round and comprises a periphery, and the first and second side edges comprise respective portions of the periphery.

4. The fluid processing device of claim 1, wherein the fluid communication comprises at least one hydrophobic surface adapted to prevent an aqueous solution from passing from the at least one feed channel into the respective through-hole.

5. The fluid processing device of claim 2, further comprising an input port and a reservoir in fluid communication with the input port, wherein the reservoir is in fluid communication with the at least one feed channel.

6. The fluid processing device of claim 1, wherein each respective fluid communication comprises a channel.

7. The fluid processing device of claim 1, wherein the substrate comprises a rectangular plate.

8. The fluid processing device of claim 1, further comprising a first cover layer sealed to the first surface and a second cover layer sealed to the second surface.

9. The fluid processing device of claim 1, wherein the substrate comprises a polymeric material.

10. The fluid processing device of claim 1, wherein the zig-zag-shaped feed channel comprises a series of V-shaped sections.

11. The fluid processing device of claim 10, wherein each V-shaped section defines a first volume and each through-hole defines a second volume that is about the same as the first volume.

12. The fluid processing device of claim 1, wherein the second surface comprises a tapered entry for each through-hole.

13. The fluid processing device of claim 12, wherein each tapered entry comprises a flat surface that is about perpendicular to the second surface.

14. The fluid processing device of claim 1, further comprising a reagent-containing bead in at least one of the through-holes.

15. The fluid processing device of claim 14, wherein each reagent-containing bead has been melted onto an interior surface of the respective through-hole.

16. The fluid processing device of claim 14, wherein the reagent-containing bead comprises a polyethylene glycol or polyethylene glycol derivative material.

17. A sample processing system comprising:
a fluid processing device comprising a substrate, the substrate comprising a first surface, an opposite second surface, a plurality of through-holes extending from the first surface to the second surface, a first side edge, a second side edge opposite the first side edge, and at least one feed channel, the at least one feed channel comprising a zig-zag shape and including a plurality of peaks and a plurality of troughs, wherein each of the peaks is closer to its corresponding trough is to the first side edge, each of the troughs is closer to the second side edge than its corresponding peak is to the second side edge, and each of the troughs is in fluid communication with at least one of the plurality of through-holes through a respective fluid communication, wherein each respective fluid communication is adapted to prevent an aqueous solution from passing from the at least one feed channel into the respective at least one through-hole under a force required for loading an aqueous solution into the at least one feed channel.
a processing apparatus, the processing apparatus comprising a rotatable platen;
a holder capable of holding the fluid processing device on or in the platen; and
a drive unit to rotate the platen about an axis of rotation.

18. A method of distributing a liquid sample comprising:
providing a fluid processing device comprising a substrate, the substrate comprising a first surface, an opposite second surface, a plurality of through-holes extending from the first surface to the second surface, a first side edge, a second side edge opposite the first side edge, and at least one feed channel, the at least one feed channel comprising a zig-zag shape and including a plurality of peaks and a plurality of troughs, wherein each of the peaks is closer to the first side edge than its corresponding trough is to the first side edge, each of the troughs is closer to the second side edge than its corresponding peak is to the second side edge, and each of the troughs is in fluid communication with at least one of the plurality of through-holes through a respective fluid communication, wherein each respective fluid communication is adapted to prevent an aqueous solution from passing from the at least one feed channel into the respective at least one through-hole under a force required for loading an aqueous solution into the at least one feed channel;
introducing a liquid sample into the feed channel of the fluid processing device; and
centrifugally spinning the fluid processing device to force liquid sample from the feed channel into one or more of the plurality of through-holes.

19. The method of claim 18, further comprising covering one or more of the first surface and the second opposite surface with a respective cover layer.

20. The method of claim 18, further comprising heating the liquid sample in the one or more of the plurality of through-holes.

21. The method of claim 20, wherein the heating comprises thermal-cycling.

22. The method of claim 21, further comprising subjecting liquid sample in the one or more of the plurality of through-holes, to a polymerase chain reaction.

23. A method comprising:
depositing at least one meltable reagent-containing bead into at least one well in an array of wells formed in a substrate, the wells communicating with one another through a channel network, the channel network adapted to prevent an aqueous solution from passing from the channel network into at least one of the wells of the array under a force required for loading an aqueous solution into the at least one well;
sealing the wells;
orienting the substrate such that the reagent-containing meltable bead moves to a desired location in the at least one well; and
melting the bead to a surface of the at least one well after the bead has been moved to the desired location.

24. The method of claim 23, wherein the meltable bead comprises a meltable wax bead.

25. The method of claim 23, wherein the at least one meltable reagent-containing bead comprises at least two different meltable reagent-containing beads, the at least one well comprises at least two wells, and the method comprises depositing a different respective meltable reagent-containing bead in each of the at least two wells.

26. The method of claim 23, wherein the at least one meltable reagent-containing bead comprises one or more probes for nucleic acid analysis.
